(19) United States
(12) Patent Application Publication
(10) Pub. No.: US 2025/0200353 A1
(43) Pub. Date: Jun. 19, 2025

(54) TECHNIQUES FOR AUGMENTED MACHINE LEARNING WITH RESPECT TO VARIATIONS OF OBJECTS

(71) Applicant: LUMANA INC., Sunnyvale, CA (US)

(72) Inventors: Noam ROTSTEIN, Haifa (IL); Ron SLOSSBERG, Raanana (IL); Aviad ZABATANI, Kfar Vitkin (IL); Ofir MULLA, Talme Elazar (IL); Amit BRACHA, Ramat Gan (IL); Ron KIMMEL, Haifa (IL)

(73) Assignee: LUMANA INC., Sunnyvale, CA (US)

(21) Appl. No.: 18/539,897

(22) Filed: Dec. 14, 2023

(51) Int. Cl. G06N 3/08; G06N 3/0455; G06N 3/0475

(52) U.S. Cl. CPC G06N 3/08; G06N 3/0455; G06N 3/0475

(57) ABSTRACT

A system and method for augmented machine learning. A method includes synthesizing a plurality of second visual content samples, wherein synthesizing the plurality of second visual content samples further comprises removing at least a portion of a plurality of first visual content samples with respect to an object in order to create a plurality of removed portion visual content items and providing the plurality of removed portion visual content items to a generative machine learning model, wherein the generative machine learning model is trained to generate at least a portion of visual content with respect to the plurality of removed portion visual content items; creating a training set including the synthesized visual content samples; and training a machine learning model using the training set, wherein the machine learning model is trained to classify visual content with respect to the object.

### TECHNICAL FIELD

The present disclosure relates generally to machine learning, and more specifically to machine learning using data sets augmented with synthesized samples.

### BACKGROUND

Using machine learning with respect to images presents various technical challenges. As a particular example, objects having the same color may appear differently in images depending on surrounding factors (e.g., lighting, reflections, etc.). Training machine learning models with samples taken at different lighting may therefore result in models which are not trained to accurately detect colors in subsequent samples. In other words, the resulting color detecting machine learning models are often not resilient to changes in lighting.

Further, effective machine learning requires using a training set which provides sufficient information about examples in a population. For example, when 99% of a population belongs to one classification, training a model using samples drawn from that population will likely result in a model which will have difficulty detecting the other classifications from the remaining 1% of the population. As a further example for color detection, when 0.01% of objects shown in images among training data are purple, the resulting machine learning model may have difficulty detecting purple-colored objects.

These and other technical challenges may prevent machine learning models from being trained to effectively detect certain classifications, particularly when the sample size for those classifications is small. Obtaining sufficient numbers of samples for smaller sample size classifications can be difficult, particularly when using existing samples for training data (as opposed to creating new samples, where additional samples can be obtained through additional manual labor). When using existing samples (e.g., samples available via public databases and/or via the Internet), the number of samples for uncommon classifications may be limited, thereby preventing effective training with respect to those uncommon classifications.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for augmented machine learning. The method comprises: synthesizing a plurality of second visual content samples, wherein synthesizing the plurality of second visual content samples further comprises removing at least a portion of a plurality of first visual content samples with respect to an object in order to create a plurality of removed portion visual content items and providing the plurality of removed portion visual content items to a generative machine learning model, wherein the generative machine learning model is trained to generate at least a portion of visual content with respect to the plurality of removed portion visual content items; creating a training set including the synthesized visual content samples; and training a machine learning model using the training set, wherein the machine learning model is trained to classify visual content with respect to the object.

Certain embodiments disclosed herein also include a non-transitory computer readable medium having stored thereon causing a processing circuitry to execute a process, the process comprising: synthesizing a plurality of second visual content samples, wherein synthesizing the plurality of second visual content samples further comprises removing at least a portion of a plurality of first visual content samples with respect to an object in order to create a plurality of removed portion visual content items and providing the plurality of removed portion visual content items to a generative machine learning model, wherein the generative machine learning model is trained to generate at least a portion of visual content with respect to the plurality of removed portion visual content items; creating a training set including the synthesized visual content samples; and training a machine learning model using the training set, wherein the machine learning model is trained to classify visual content with respect to the object.

Certain embodiments disclosed herein also include a system for augmented machine learning. The system comprises: a processing circuitry; and a memory, the memory containing instructions that, when executed by the processing circuitry, configure the system to: synthesizing a plurality of second visual content samples, wherein synthesizing the plurality of second visual content samples further comprises removing at least a portion of a plurality of first visual content samples with respect to an object in order to create a plurality of removed portion visual content items and providing the plurality of removed portion visual content items to a generative machine learning model, wherein the generative machine learning model is trained to generate at least a portion of visual content with respect to the plurality of removed portion visual content items; creating a training set including the synthesized visual content samples; and training a machine learning model using the training set, wherein the machine learning model is trained to classify visual content with respect to the object.

Certain embodiments disclosed herein include the method, non-transitory computer readable medium, or system noted above or below, further including or being configured to perform the following step or steps: segmenting the plurality of first visual content samples with respect to the object, wherein the at least a portion of the plurality of first visual content samples is removed based on the segmenting of the plurality of first visual content samples with respect to the object.

Certain embodiments disclosed herein include the method, non-transitory computer readable medium, or system noted above or below, wherein segmenting each of the plurality of first visual content samples results in at least one set of pixels corresponding to the object for each first visual content sample, wherein the at least one set of pixels corresponding to the object are removed from at least one of the plurality of first visual content samples.

Certain embodiments disclosed herein include the method, non-transitory computer readable medium, or system noted above or below, further including or being configured to perform the following step or steps: querying the generative machine learning model with respect to the plurality of first visual content samples, wherein the query indicates a variation of the object for which the at least a portion of visual content is to be generated by the generative machine learning model.

Certain embodiments disclosed herein include the method, non-transitory computer readable medium, or system noted above or below, wherein the trained machine learning model has a plurality of weights, further including or being configured to perform the following step or steps: applying the trained machine learning model to at least one evenly distributed data set in order to produce a set of outputs with respect to the at least one evenly distributed data set, each evenly distributed data set including an evenly distributed set of visual content samples, wherein the trained machine learning model outputs a classification for each visual sample among each evenly distributed data set; and adjusting at least one weight plurality of weights based on the set of outputs with respect to the at least one evenly distributed data set.

Certain embodiments disclosed herein include the method, non-transitory computer readable medium, or system noted above or below, wherein the generative machine learning model is a first generative machine learning model, wherein the trained machine learning model has a plurality of thresholds, further including or being configured to perform the following step or steps: querying a second generative machine learning model for distribution data of a population set; and adjusting at least one threshold of the plurality of thresholds based on the distribution data of the population set.

Certain embodiments disclosed herein include the method, non-transitory computer readable medium, or system noted above or below, wherein the at least one threshold is adjusted such that the trained machine learning model achieves a predetermined precision rate.

Certain embodiments disclosed herein include the method, non-transitory computer readable medium, or system noted above or below, wherein the second generative machine learning model is a large language model.

Certain embodiments disclosed herein include the method, non-transitory computer readable medium, or system noted above or below, wherein the generative machine learning model is a diffusion model.

Certain embodiments disclosed herein include the method, non-transitory computer readable medium, or system noted above or below, further including or being configured to perform the following step or steps: applying the trained machine learning model to a plurality of third visual content samples.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flow diagram illustrating content synthesis which may be utilized in accordance with various disclosed embodiments.

FIGS. 3A-B are flow diagrams utilized to illustrate synthesizing samples in accordance with various disclosed embodiments.

FIG. 4 is a flowchart illustrating a method for configuring a machine learning model using augmented data sets according to an embodiment.

FIG. 5 is a flowchart illustrating a method for synthesizing data according to an embodiment.

FIG. 6 is a flowchart illustrating a method for tuning a machine learning model to reduce bias according to an embodiment.

FIG. 7 is a flowchart illustrating a method for setting thresholds for a machine learning model based on a global distribution according to an embodiment.

FIG. 8 is a schematic diagram of a machine learning augmenter according to an embodiment.

### DETAILED DESCRIPTION

The embodiments disclosed herein include techniques for training machine learning models to accurately detect attributes based on training sets in which at least some instances of those attributes are uncommon (i.e., that do not appear in the training set or appear less than a threshold number of times in the training set). More specifically, various disclosed embodiments provide techniques which allow for training machine learning models to accurately identify instances of uncommon attributes without requiring a data set including many examples of the uncommon attributes. The disclosed embodiments also provide techniques for further improving the accuracy of machine learning model outputs via tuning and setting thresholds.

In an embodiment, visual content to be used for training a machine learning model with respect to a predefined type of attribute is utilized to generate synthesized visual content. To this end, in various embodiments, the visual content shows examples of an attribute in the form of objects demonstrating different variations of the object (e.g., variations having different attributes, variations demonstrating presence or absence of the object). The machine learning model may be a classifier configured to output classifications, for example, a type of variation of the object shown in visual content or whether a given portion of visual content demonstrates an object having a particular attribute. The visual content and synthesized visual content are used to create a training set, which in turn is utilized to train the machine learning model. The machine learning model can then be applied to subsequent visual content in order to identify, for example, a variation of the object (e.g., a particular color of an article of clothing), whether or not the object is present (e.g., whether a person shown in an image is wearing a hard hat or not), and the like.

The synthesis includes removing portions of the visual content including objects demonstrating a variant of a given object and replacing the removed portions with new portions demonstrating different variants of the object (e.g., variants of the object having different attribute, or a variant of an image showing an object where the variant does not show the object). The result is a set of removed portion visual content items. As a non-limiting example, synthesis with respect to colors of shirts (i.e., the attribute is color as reflected in objects that are articles of clothing) may include removing portions of images showing red shirts and replacing the removed portions of the images with portions of images showing pink shirts. As another non-limiting example, synthesis with respect to presence or absence of hard hats (i.e., the attribute is the presence or absence of a hard hat reflected in objects or lack of objects in the form of hard hats) may include removing hard hats from images and replacing the removed portions of the image with portions showing hair or another top of the head.

Further, the synthesis may include applying a detector to detect samples containing relevant objects (e.g., shirts when the attribute is shirt color, hard hats when the attribute is presence or absence of hard hats, etc.). The detected samples containing the relevant objects are analyzed via segmentation in order to identify sets of pixels in each sample representing the relevant objects. The identified sets of pixels may be removed, thereby resulting in removed portion visual content items.

Replacing the removed portions may include, but is not limited to, providing the removed portion visual content items to a generative artificial intelligence (AI) model such as, but not limited to, a diffusion model, that is trained to generate visual content based on a prompt. To this end, the prompt may further include textual content or other content indicating a desired variant of the object for the portions of visual content to be generated to replace the removed portions. As a non-limiting example, when the removed portions are samples including shirts of more common colors (e.g., red, blue, etc.), the removed portion visual content items may be provided to the generative artificial intelligence model along with a textual query stating “Please replace the removed portion with a purple shirt.”

In this regard, it is noted that existing generative Al models are trained to produce visual content taking into account factors such as angles of images, lighting in images, and the like, which may therefore be utilized to generate portions of visual content that capture colors or other features accurately. It has further been identified that such generative Al models perform better (i.e., generating more accurate portions of visual content) when prompted to fill in portions of visual content which are missing as compared to when prompted to alter the color or other appearance of an existing portion of visual content. Accordingly, removing portions of objects demonstrating common attributes from the visual content allows for producing more realistic-looking synthesized visual content samples, which in turn allows for improving the accuracy of the machine learning model trained using the synthesized samples.

When the machine learning model has been trained, it may be refined via tuning of weights, adjusting thresholds, both, and the like. To this end, the processes described here include techniques for tuning weights to reduce bias as well as for adjusting thresholds based on global distributions. These refinement processes may be further utilized to improve the model and to overcome inherent biases in smaller training datasets or otherwise in datasets where certain attributes or other variations of objects are uncommon (e.g., when colors of shirts are used and pink shirts only appear in a very low proportion of images).

To this end, in an embodiment, the trained model is applied to an evenly distributed data set. The evenly distributed data set includes an equal number of samples representing each potential classification. As a non-limiting example, for a population of 100 samples showing different colored shirts, an evenly distributed data set includes 10 images showing each color of shirt among 10 potential colors of shirts. Weights of the model are adjusted based on classifications output by the model as applied to the evenly distributed data set.

In this regard, it is noted that machine learning models are inherently biased by the training data used to train those models. Training sets are often not evenly distributed and, as a result, may include unequal numbers of samples showing different attributes or combinations of attributes. By adjusting the weights of the machine learning models based on outputs of the models when applied to evenly distributed data sets, biases caused by uneven distribution of samples in the original training set used to train the model can be mitigated in order to create an unbiased (or less biased) model. As noted above, certain processes utilize synthesized data which may not include many samples of certain kinds of uncommon variations. Accordingly, reducing bias in this manner allows for effectively utilizing the synthesized data to train machine learning models while retaining model accuracy.

In another embodiment, thresholds for outputting classifications are adjusted based on a global distribution. More specifically, statistical data related to the global distribution are used in order to determine relative proportions of different potential output classifications, and the thresholds are adjusted based on the determined proportions. As a non-limiting example, thresholds are adjusted such that they are inversely proportional to the proportion of a given classification such that a higher proportion of that classification results in a lower threshold and a lower proportion of that classification results in a higher threshold. That is, classifications which appear in a higher proportion of samples among the global distribution are given lower thresholds, which in turn results in the thresholds for those high proportion classifications to be met more easily, thereby increasing the likelihood that the model outputs higher proportion classifications than lower proportion classifications.

In this regard, it is noted that the distribution of different variations in a given training set may not accurately represent the global population. For example, a training set including images showing different colors of shirts may not include the appropriate proportions of shirt colors as would be observed among all images showing people wearing shirts. This is particularly true when an evenly distributed data set is applied to remove bias from the model since many populations are not evenly distributed. Adjusting thresholds based on global distributions allows for training the model based on a smaller data set while improving accuracy in a manner similar to improvements which might be realized by training using a larger data set. Accordingly, various processes described here can be utilized to efficiently train machine learning models based on smaller training sets, thereby conserving computing resources related to generating synthesized data for training sets as well as for performing the training itself.

Moreover, in order to obtain global distributions for use in setting thresholds, some embodiments include techniques for querying a large language model (LLM) or other large generative machine learning model in order to obtain distribution data. Such a large generative machine learning model may be an artificial neural network trained on a large number of parameters (e.g., billions of parameters). To this end, in an example implementation, a textual query for distribution information is generated and used to query a LLM. As a non-limiting example, the textual query may be “What percent of shirts shown in images are purple?”, and the LLM may return a result like “Out of all of the examples I have seen approximately two percent of shirts are purple.” Based on text returned by the LLM, the distribution (or a portion of the distribution) is determined. The determined distribution is used to adjust the thresholds of the machine learning model.

In this regard, it is noted that some existing LLMs and other large generative machine learning models trained based on large data sets are effectively trained on a global sample set by using data taken from the Internet or other large public sources of data. Moreover, some LLMs have bene designed to recognize visual content and not only text. Accordingly, these large generative machine learning models effectively have access to information for a global distribution, and are capable of responding to textual queries regarding the data it was trained on such as textual queries about statistics of that data. It has therefore been identified that existing LLMs or other large generative machine learning models can be leveraged in order to improve machine learning model accuracy by leveraging global distribution data accessible via those large generative machine learning models. Consequently, the thresholds can be accurately adjusted using LLMs in order to improve the accuracy of the machine learning model outputs without needing to train on the full global dataset.

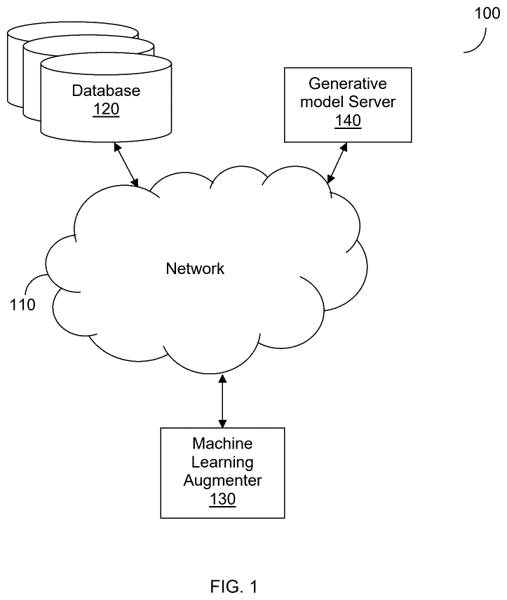

FIG. 1 is a network diagram 100 utilized to describe various disclosed embodiments. In the example network diagram 100, one or more databases 120, a machine learning augmenter 130, and a generative model server 140 communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The databases 120 stores samples of content to be used for training machine learning models. In accordance with various disclosed embodiments, the samples include samples of visual content such as, but not limited to, images, video, combinations thereof, portions thereof, and the like. Features from these samples may be extracted and utilized for training of machine learning models as discussed herein. The databases 120 may be, but are not limited to, publicly accessible databases such as image or video repositories available via the Internet.

The machine learning augmenter 130 is configured to augment the samples stored in the databases as discussed herein. More specifically, in accordance with various disclosed embodiments, the machine learning augmenter 130 is configured to synthesize visual content samples in order to supplement samples, for example, available via the databases 120. The machine learning augmenter 130 is further configured to train one or more machine learning models using the synthesized samples, for example but not limited to, using a training set including the synthesized samples as well as other samples from the databases 120. To this end, in various embodiments, the machine learning augmenter 130 is configured to detect objects in visual content, to segment content with respect to objects, to remove portions of visual content, and to provide removed portion visual content samples to one or more generative machine learning models (e.g., models accessible via the generative model server 140) in order to obtain synthesized visual content samples.

In accordance with various disclosed embodiments, the machine learning augmenter 130 is further configured to tune weights of the machine learning models trained by the machine learning augmenter 130, thresholds used for those machine learning models, or both, in order to refine the machine learning models' performance.

The generative model server 140 hosts a service by which one or more generative machine learning models (not shown) can be accessed. In accordance with various disclosed embodiments, the machine learning augmenter 130 is configured to utilize generative machine learning models such as the generative machine learning models accessible via the generative model server 140 in order to aid in creation of synthesized samples.

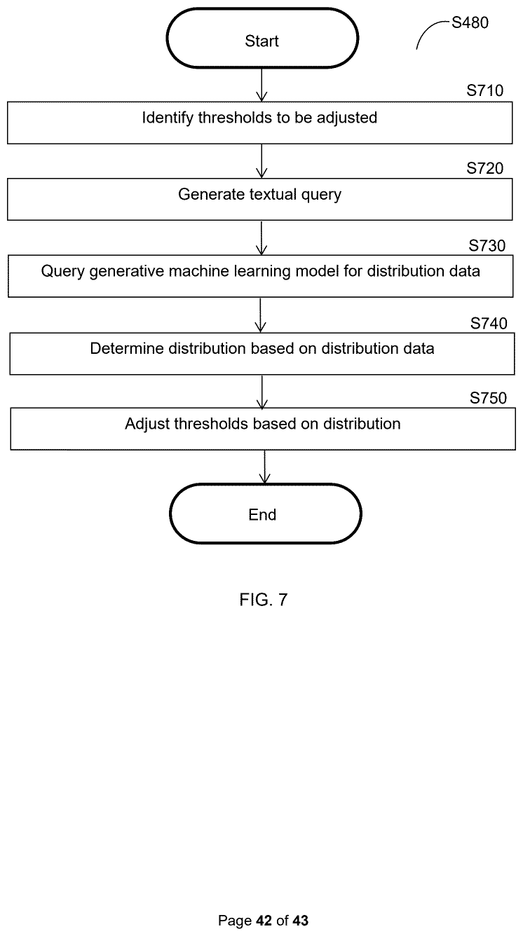

In some embodiments, the generative model server 140 is configured to receive requests and to generate queries for a generative machine learning model such as, but not limited to, a large language model (LLM). More specifically, as discussed further below (e.g., with respect to FIG. 7), in some embodiments, the machine learning augmenter 130 is configured to query or send requests to query a generative machine learning model with respect to a population (e.g., using a textual query) in order to obtain responses from the generative machine learning model including data about the population such as, but not limited to, a relative number of samples among the population demonstrating a particular classification. As described herein, such data about the population may be utilized to adjust thresholds of the machine learning models trained as described herein in order to further improve the accuracy of classification by those machine learning models.

It should be noted that a generative model server 140 is depicted in FIG. 1 for example purposes, but that the disclosed embodiments are not necessarily limited as such. In particular, any or all of the generative machine learning models used pursuant to any or all of the disclosed embodiments may be deployed locally with respect to the machine learning augmenter 130 or other system configured to perform at least a portion of the disclosed embodiments. In other words, the generative machine learning models may be stored in and executed by such a system, or may be accessible to the system via one or more local connections, networks, both, and the like.

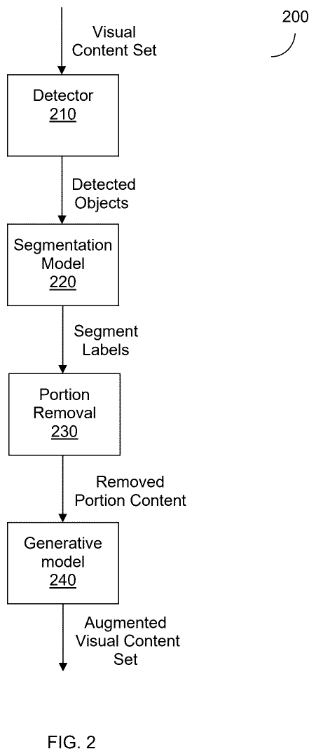

FIG. 2 is a flow diagram 200 illustrating content synthesis which may be utilized in accordance with various disclosed embodiments.

As shown in FIG. 2, visual content samples from among a visual content set are input to a detector 210. The detector 210 is configured to detect objects, and outputs data indicating the detected objects. Such data may include, but is not limited to, bounding boxes surrounding portions of visual content showing the detected objects. The data indicating the detected objects is input to a segmentation model 220, which is configured to segment the visual content samples with respect to the detected objects. The result may be or may include a segmentation mask, which is a portion of visual content representing a segment. The segmentation mask may further include a set of segment labels, for example, labels for each pixel indicating a segment to which the pixel belongs. At least some of the segments represent the detected objects.

The outputs of the segmentation model 220 are provided for portion removal 230. In accordance with various disclosed embodiments, the portion removal 230 may be performed in order to generate remove portion samples. More specifically, portions of content showing one or more objects of interest such as, but not limited to, objects for which training samples are to be used for training machine learning models, are removed. In particular, in accordance with various disclosed embodiments, the portion removal 230 is utilized to remove portions of content showing objects having certain classifications such that the removed objects may be replaced with portions showing objects having different classifications. Some non-limiting examples include removing portions of images showing articles of clothing in order to replace those articles of clothing with articles of clothing having different colors, removing portions of images showing headwear (e.g., hard hats) in order to replace the headwear with other headwear (e.g., other types of hats) or no headwear (e.g., hair or otherwise a head without a hat).

The removed portion visual content items or other removed portion content is input to a generative machine learning model 240. In accordance with various embodiments, the inputs to the generative machine learning model 240 further include textual content indicating criteria for the content to be generated by the generative machine learning model 240. As a non-limiting example, when a portion showing a green color shirt is removed from the initial image to create an image of a person with the shirt excluded, a textual input to the generative machine learning model 240 may be “Add a purple shirt to this image.” As another non-limiting example, when a portion showing a hard hat is removed from the initial image to create an image of a person with nothing on top of their head, a textual input to the generative machine learning model 240 may be “Add hair to this image.”

The generative machine learning model 240 is trained to generate visual content or portions thereof based on inputs provided to the generative machine learning model 240. To this end, in an embodiment, the generative machine learning model 240 is a diffusion model trained to generate data based on noise. A non-limiting example of such a diffusion model is DALL-E 2, which is trained to create images based on textual inputs. In a further embodiment, the diffusion model is configured to destroy training data through successive addition of Gaussian noise, and trained to recover the data via reversal of the noise addition process. To this end, such a diffusion model may be trained by causing the diffusion model to add noise to images and to learn how to remove noise from those images.

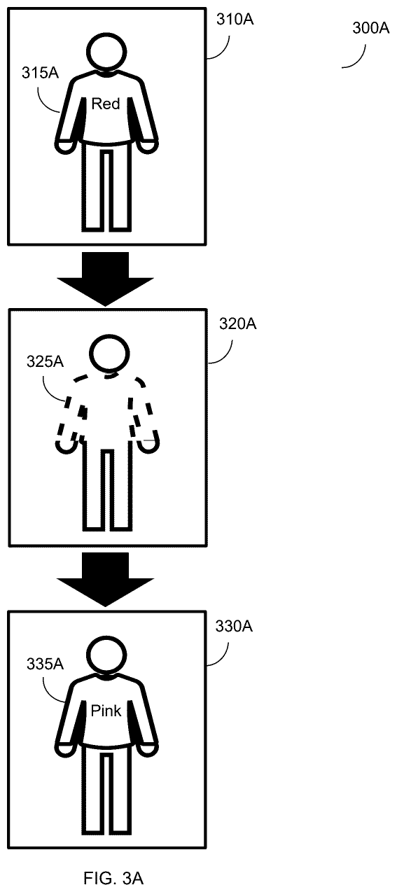

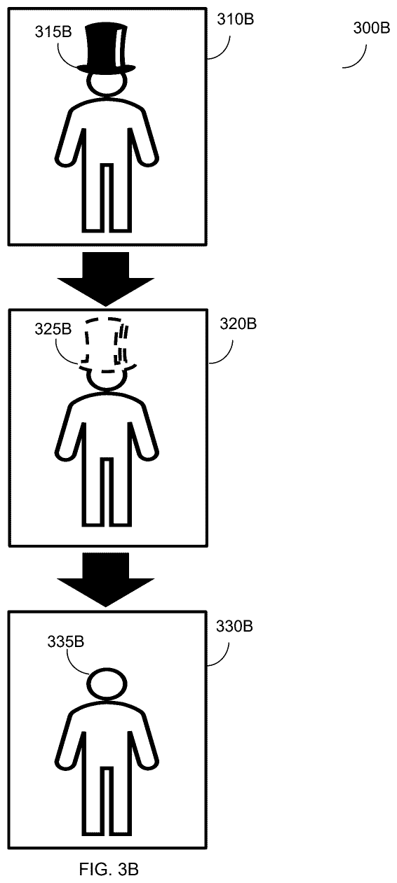

FIGS. 3A-B are flow diagrams 300A and 300B, respectively, utilized to illustrate synthesizing samples in accordance with various disclosed embodiments.

As depicted in the flow diagram 300A, a first image 310A depicts a person wearing a red shirt portion 315A. The red shirt image 310A is input to segmentation and portion removal processes as discussed above in order to yield a second image 320A in which a portion showing the shirt has been removed, thereby containing a removed portion 325A. The removed portion image 320A is input to a generative artificial intelligence model (e.g., a diffusion model such as the generative machine learning model 240, FIG. 1) in order to obtain generated content such as a generated pink shirt portion 335A. The pink shirt portion 335A is added to the removed portion image 320A to replace the removed portion 325A, thereby resulting in a third image 330A which is a synthesized image showing the same person as the first image 310A but wearing a pink shirt instead of a red shirt.

When pink shirts are uncommon among the samples in a visual content set, creating pink shirt examples in this manner may allow for training machine learning models to better recognize pink shirts. In other words, the synthesized samples may be used to supplement examples of people wearing different color shirts in order to improve recognition of shirts which are not commonly shown in the examples from the visual content set.

As depicted in the flow diagram 300B, a first image 310B depicts a person wearing a top hat 315B. The top hat image 310B is input to segmentation and portion removal processes as discussed above in order to yield a second image 320B in which the top hat has been removed, thereby containing a removed portion 325B. The removed portion image 320B is input to a generative artificial intelligence model (e.g., a diffusion model such as the generative machine learning model 240, FIG. 1) in order to obtain generated content such as a generated head top portion 335B showing a top of a person's head without a hat (e.g., a portion showing hair). The head top portion 335B is added to the removed portion image 320B to replace the removed portion 325B, thereby resulting in a third image 330B which is a synthesized image showing the same person as the first image 310B but wearing no hat (i.e., hatless).

When all examples showing people in a given environment (e.g., a construction site) show people wearing hard hats or other safety headgear, a machine learning model trained using those examples may become biased to falsely detect safety headgear being worn based on the environment (i.e., a particular construction site shown in the background). By providing additional examples showing people not wearing safety headgear in that environment, false positive detection of safety headgear objects based on background can be mitigated or avoided.

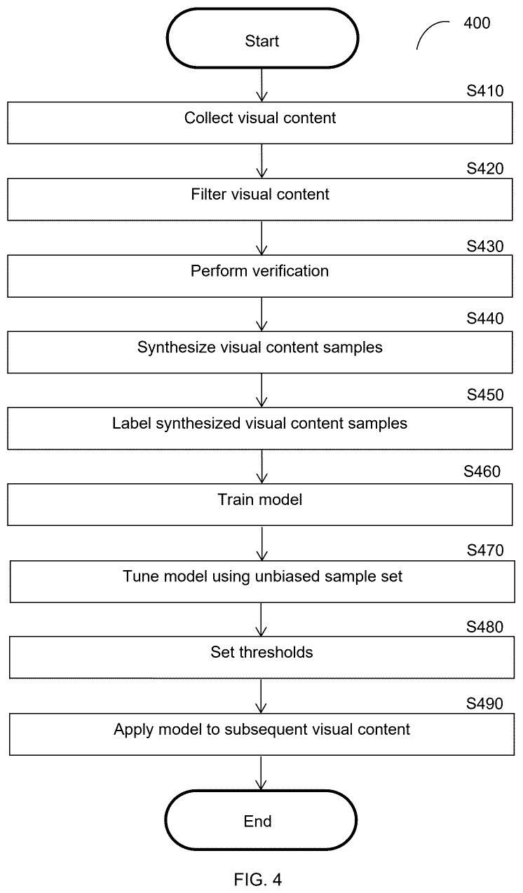

FIG. 4 is a flowchart 400 illustrating a method for configuring a machine learning model using augmented data sets according to an embodiment. In an embodiment, the method is performed by the machine learning augmenter 130, FIG. 1.

At S410, visual content is collected. The visual content may be collected via one or more cameras deployed so as to capture potentially relevant samples, or may be retrieved from one or more databases. At least some of the collected visual content shows instances of a predetermined object (i.e., a type of object such as a shirt or hat) which a machine learning model is to be trained to detect variations of.

At optional S420, the visual content may be filtered. The filtering may be used in order to reduce the amount of samples among the visual content to be labeled, used for training, or otherwise subsequently processed. The filtering may be performed based on filtering criteria which may depend on the implementation such as, but not limited to, criteria defined with respect to shapes of images, of sizes of images, of variety among images (i.e., such that excessive amounts of redundant images which show the same variation of an object over a threshold number of times are filtered out), combinations thereof, and the like.

At optional S430, verification is performed with respect to the visual content. The verification may be performed with respect to certain objects shown in the visual content, which may vary depending on the implementation. As a non-limiting example it may be verified whether each image or frame among the visual content shows a human. In some implementations, the verification may further include determining whether the same subject (e.g., the same human) is shown in different visual content samples.

At S440, visual content samples are synthesized using at least a portion of the visual content. More specifically, in an embodiment, visual content samples are synthesized using generative artificial intelligence (AI) techniques. The visual content samples are visual content items generated in order to serve as examples of certain variations with respect to predetermined objects (e.g., objects of interest which are pre-designated). To this end, the visual content samples may be alternate versions of visual content items among the visual content which have been edited to replace objects shown in those visual content items with objects demonstrating different variations.

The synthesized visual content samples may demonstrate rare or otherwise uncommon variations such as variations having uncommon colors, shapes, types. As a non-limiting example, visual content samples may be synthesized to show shirt colors which appear relatively infrequently among the visual content samples (e.g., below a predetermined threshold) or otherwise to show desired shirt colors for a given implementation. Alternatively or in combination, the synthesized visual content samples may demonstrate variations that remove the object entirely and replace it with an entirely different object. As a non-limiting example, visual content samples may be synthesized to remove hats from existing visual samples (e.g., by replacing hats shown in the visual content samples with hair or otherwise with visual content representing a top of a human's head).

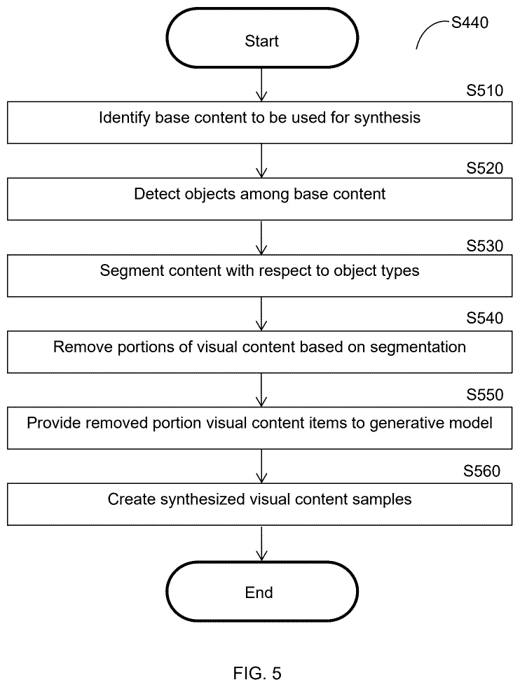

In a further embodiment, synthesizing the samples includes segmenting content with respect to the predetermined objects, removing portions of content showing the predetermined objects out of existing samples among the visual content, using a generative machine learning model to generate portions of content to be used to replace the removed portions of content, combinations thereof, and the like. An example process for synthesizing data which may be utilized at S440 is described further below with respect to FIG. 5.

At optional S450, the synthesized visual content samples may be labeled. More specifically, as noted above, each synthesized visual content sample is a visual content item which is generated with respect to a particular variation of an object. Such variations may include, but are not limited to, color, shape, type, presence or absence (i.e., whether the object is present in the image or not), combinations thereof, portions thereof, and the like. The synthesized visual content samples may be labeled based on the respective variations shown in each of the synthesized visual content samples. Such labeling may be used in order to facilitate training the machine learning model at S460 using the synthesized visual content samples via supervised machine learning.

In some implementations, S450 may include providing the synthesized visual content samples to human operators for annotation in order to obtain the labels. In other implementations, the synthesized visual content samples may be automatically labeled, for example, based on textual inputs used during creation of the synthesized visual content samples or otherwise based on classifications indicating variations each synthesized visual content sample is created to represent.

At S460, a machine learning model is trained. In an embodiment, the machine learning model is trained at least using the synthesized visual content samples and at least a portion of other visual content (such as, but not limited to, the visual content collected at S410 which was used to generate the synthesized visual content samples). In other words, the machine learning model may be trained using at least some samples from a first set of visual content samples as well as at least some samples from a second set of visual content samples, where the second set of visual content samples includes synthesized visual content samples created based on at least a portion of the first set of visual content samples.

In an embodiment, the machine learning model is trained such that the machine learning model is configured to output classifications or other predictions defined with respect to one or more predetermined objects when applied to inputs including visual content items such as images or video frames. The machine learning model may be further configured to output likelihood scores for its predictions. Each likelihood score may indicate a degree of likelihood that a respective prediction is correct, and may be used for purposes such as determining whether to output certain predictions using thresholds as discussed further below.

In a further embodiment, the machine learning model is trained using supervised machine learning based on a training set including training visual content items and corresponding variation labels, where each variation label corresponds to a respective training visual content item and may indicate a classification defined with respect to an object (e.g., a color of the object, a shape of the object, a type of the object, whether the object is present or not, and the like). As noted above, the training visual content items at least include the synthesized visual content samples, and may further include any or all of the original visual content samples based on which the synthesized visual content samples were created.

In some embodiments, the synthesized visual content samples are variants of respective original visual content samples which were used to create the synthesized visual content samples (e.g., visual content samples among the visual content collected at S410) such that the synthesized visual content samples show, for example but not limited to, the same people, animals, other objects, or environments as the original visual content samples, but with a different variation of one or more predetermined objects shown therein. As a non-limiting example, when the original visual content samples include an image of a particular person wearing a red shirt that is used to create a synthesized visual content sample showing that same person having the shirt replaced with a purple shirt, the machine learning model is trained using both the original red shirt visual content sample showing that person as well as the variant synthesized purple shirt visual content sample showing that person. Using images of the same person featuring different variations of objects may further improve the training of the machine learning model by effectively highlighting the relevant differences between variations.

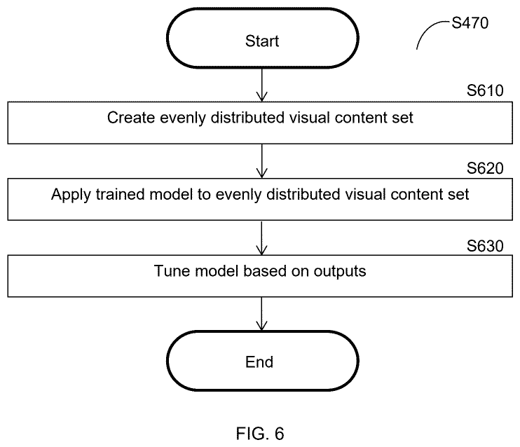

At optional S470, the machine learning model is tuned. In an embodiment, the machine learning model may be tuned using one or more unbiased sample sets. In a further embodiment, each unbiased sample set is evenly distributed such that the unbiased sample set includes an equal (or approximately equal, as defined via a predetermined threshold) number of samples showing each of two or more variations. To this end, tuning the machine learning model may include applying the machine learning model to the sample set and adjusting weights of the machine learning model based on the outputs of the machine learning model, for example as compared to a known even distribution. An example process for tuning a machine learning model which may be utilized at S470 is described further below with respect to FIG. 6.

At optional S480, thresholds of the machine learning model may be calibrated, adjusted, or otherwise set. Specifically, the thresholds may include thresholds used to determine whether a given classification should be output by the machine learning model, and any or all of the thresholds may be adjusted in order to change the likelihood of outputting respective classifications.

In some embodiments, the thresholds may be calibrated to meet one or more predetermined requirements. Such requirements may include, but are not limited to, a predetermined minimal precision rate (i.e., such that the thresholds meet the predetermined requirements when the model with those thresholds achieves the predetermined minimal precision rate. In a further embodiment, the thresholds may be calculated using statistical techniques based on a known distribution (e.g., a distribution defined via distribution data of a population as follows).

In an embodiment, the thresholds are adjusted based on distribution data with respect to a population, where the population has a population data set including population samples showing variations with respect to the predetermined object, and the number of population samples is greater than the number of visual content samples used to train the machine learning model. In other words, the machine learning model is trained based on a limited subset of possible samples, and the population data effectively represents a broader population by including more samples (e.g., orders of magnitude more samples). By adjusting thresholds based on this distribution data, the machine learning model becomes configured to generate more accurate predictions without needing to train using the entire set of population data.

In a further embodiment, the distribution data is obtained using one or more generative machine learning models trained based on a population data set. Such a generative machine learning model may be, but is not limited to, a large language model (LLM). When a LLM is utilized, S480 may include querying the LLM using a textual query including one or more questions related to the population data, and obtaining outputs from the LLM indicating answers to the questions in the form of distribution data.

In this regard, it is noted that certain kinds of machine learning models, for example classifiers, may return a score for each output indicating a likelihood that the output is correct. Thresholds may be used such that outputs having scores below the respective threshold are not returned. Such thresholds may be used to safeguard against returning outputs that are likely incorrect even though those outputs are effectively a “best guess.” Tuning these thresholds therefore allows for obtaining more accurate outputs from a machine learning model.

It is also noted that large generative machine learning models (e.g., LLMs) are trained based on high numbers of examples, for example, in data found across the Internet, and that some of these generative machine learning models are capable of providing information about examples they have observed in response to prompts included in queries. Thus, querying these large generative machine learning models in order to obtain the distribution data effectively allows for obtaining distribution data for a given population with respect to an object of interest (i.e., the predetermined object), which in turn can be used to adjust the thresholds of a machine learning model (e.g., the machine learning model trained as described with respect to S460) in order to further improve its performance.

An example process for setting thresholds which may be utilized at S480 is described further below with respect to FIG. 7.

At S490, the machine learning model is applied to subsequent visual content. For example, the machine learning model is applied to subsequent visual content in order to determine a variation of objects shown in the subsequent visual content, whether the object is present in the subsequent visual content, both, and the like. As a non-limiting example, the machine learning model may be applied to video frames showing people in order to detect colors of shirts worn by the people shown in the video frames. As another non-limiting example, the machine learning model may be applied to images showing people at construction sites in order to detect whether each person is wearing a hard hat or not.

As discussed herein, the machine learning model trained using synthesized samples is trained to more accurately recognize instances of rare or otherwise uncommon variations (e.g., variations of characteristics such as color) that are observed infrequently among the data used to train the machine learning model. Accordingly, the machine learning model applied at S490 is trained to more accurately than without the synthesized samples. Further, the machine learning model may be tuned, have thresholds adjusted, or both, in order to further improve the performance of the model such that the resulting outputs are more accurately when applied at S490.

FIG. 5 is a flowchart S440 illustrating a method for synthesizing data according to an embodiment.

At S510, base content to be used for synthesis. In an embodiment, the base content is a set of visual content including samples of visual content items such as images, videos, portions thereof, and the like. For example, the base content may include the visual content collected as discussed above with respect to S410, FIG. 4.

At S520, objects among the base content are detected. In an embodiment, the objects include instances of a predetermined type of object. As a non-limiting example, the objects include instances of clothing articles or other wearable items such as shirts or hard hats.

In an embodiment, S520 includes applying a detection machine learning model configured to detect whether a predetermined type of object is present in a given visual content item (e.g., image or video frame). The detected objects may therefore be among visual content items including one or more instances of the predetermined type of object. In a further embodiment, only visual content items showing one or more instances of the predetermined type of object are used during subsequent processing, thereby reducing the number of visual content items processed during subsequent processing and, accordingly, reducing computing resource consumption for subsequent steps.

At S530, visual content items (e.g., images or frames) among the base content are segmented with respect to the detected objects by applying a segmentation model (e.g., the segmentation model 220, FIG. 2). The result is a segmentation. The segmentation includes two or more segments defined with respect to the predetermined type of object being detected. In a further embodiment, each segment is a group of portions of a visual content item (e.g., pixels of an image). In yet a further embodiment, each segment includes a group of portions of the visual content item either belonging to a class representing the predetermined type of object (e.g., a shirt class) or a class representing anything other than the predetermined type of object (e.g., a non-shirt class).

At S540, portions of the base content visual content items are removed based on the segmentation in order to result in a set of removed portion visual content items. In an embodiment, S540 includes removing each segment corresponding to the predetermined type of object. As a non-limiting example, pixels of each segment having a class “shirt” within video frames may be removed.

At S550, the removed portion visual content items are provided to a generative machine learning model in order to obtain generated visual content portions to replace the removed portions of the removed portion visual content items. In an embodiment, S550 further includes providing one or more textual inputs indicating criteria to be used for generating the visual content portions by the generative machine learning model. As a non-limiting example, an image in which a portion showing a red shirt was removed may be provided to a diffusion model along with the textual query “Please replace the removed portion of this image with a purple shirt” in order to obtain, from the diffusion model, a portion of an image showing a purple short which corresponds in shape and size to the removed portion showing the shirt.

At S560, synthesized visual content samples are created using the generated visual content portions. In an embodiment, S560 includes replacing each removed portion in each removed portion visual content item with a respective visual content portion generated by the generative machine learning model at S550. The result is a set of synthesized visual content items to act as samples for the newly generated visual content portions.

FIG. 6 is a flowchart S470 illustrating a method for tuning a machine learning model to reduce bias according to an embodiment.

At S610, one or more evenly distributed visual content sets are created. Each evenly distributed visual content set is created such that an equal amount of examples showing different variations of an object (e.g., colors of a shirt, instances of wearing hard hats and not wearing hard hats, etc.) are included. For a binary distribution, the even distribution would include an amount of examples showing a first variation and an equal amount of examples showing a second variation. For a non-binary distribution, an equal number of examples for each variation is used (e.g., 10 red shirts, 10 blue shirts, 10 green shirts, and 10 yellow shirts).

In an embodiment, an evenly distributed data set is created for each potential variation (e.g., each variation represented by a respective classification which the model is trained to detect). In a further embodiment, each evenly distributed data set follows a binary distribution, with half (or approximately half) of the samples belonging to that variation and half (or approximately half) of the samples not belonging to that variation (e.g., belonging to alternative variations). As a non-limiting example for such an embodiment, one evenly distributed data set may include 10 images showing red shirts and 10 images showing non-red shirts.

In accordance with various disclosed embodiments, at least some of the evenly distributed visual content sets include synthesized samples created as discussed above. In such embodiments, the synthesizing of samples may effectively allow for creating the evenly distributed visual content set. That is, if a sufficient number of samples of a given variation are not available in a set of visual content, the evenly distributed visual content set may be supplemented with synthesized samples.

At S620, a trained machine learning model is applied to each evenly distributed visual content set in order to result in a set of outputs for each evenly distributed visual content set, with outputs of the trained machine learning model corresponding to respective samples among the respective evenly distributed content set. In an embodiment, the machine learning model is a classifier trained as discussed above with respect to S460, and the outputs at least include classifications defined with respect to a given type of object (e.g., shirts, headwear or lack thereof, etc.).

At S630, the trained machine learning model is tuned based on the outputs. In an embodiment, S630 includes adjusting weights of the trained machine learning model based on the sets of outputs. More specifically, the weights may be adjusted based on differences between a distribution of the set of outputs and the even distribution, for example by tuning the weights such that, if the tuned machine learning model is reapplied to the evenly distributed visual content set, the resulting set of outputs will be evenly distributed. In some embodiments where each evenly distributed data set corresponds to a respective variation (e.g., an evenly showing data set with half of the samples representing that variation and half of the samples representing variations other than that variation), a weight corresponding to each variation may be adjusted based on differences between the set of outputs for the evenly distributed data set for the variation and the distribution of that evenly distributed data set.

In some embodiments, S630 may include determining whether the trained machine learning model is to be tuned based on set of outputs. In a further embodiment, S630 includes determining whether the set of outputs is evenly distributed, i.e., such that the set of outputs includes an equal number of instances of classifications corresponding to each of the possible variations represented among the classifications. As a non-limiting example, when the evenly distributed visual content set includes 10 red shirt images, 10 blue shirt images, and 10 yellow shirt images, it is determined whether or not the set of outputs includes 10 red shirt classifications, 10 blue shirt classifications, and 10 yellow shirt classifications.

FIG. 7 is a flowchart S480 illustrating a method for setting thresholds for a machine learning model based on a global distribution according to an embodiment.

At S710, the thresholds to be adjusted are identified. In an embodiment, the thresholds to be adjusted are thresholds for certain outputs (e.g., thresholds for outputting respective classifications) of a machine learning model to be refined, for example, thresholds of the machine learning model trained as discussed above with respect to S460.

At S720, a textual query is generated. The textual query is a query for data related to a population to which samples used for training the machine learning model belong. In other words, the samples used to train the machine learning model belong to a larger population data set which was used to train a generative machine learning model such as, but not limited to, a large language model (LLM).

The textual query includes text requesting data related to the distribution which may be utilized to determine the distribution. For example, the textual query may include text indicating a question asking about the number of samples in the population data set which demonstrate respective classifications used by the machine learning model to be refined. As a non-limiting example, such a textual query may be “How many shirts shown in images are each of red, blue and yellow?” As another example, the textual query may include text indicating a question asking about the proportion of samples in the population data set which demonstrate respective classifications used by the machine learning model to be refined. As a non-limiting example, such a textual query may be “What proportion of shirts shown in images are each of red, blue, and yellow?”

At S730, a generative machine learning model (e.g., a LLM) is queried for distribution data using the textual query. The generative machine learning model provides one or more outputs indicating information about the distribution. When the generative machine learning model is a LLM, the outputs of the LLM may include textual content indicating answers to the questions represented in the textual query.

It should be noted that S720 and S730 are discussed with respect to a single textual query for simplicity purposes, but that multiple textual queries may be equally utilized without departing from the scope of the disclosure. As a non-limiting example, a textual query may be generated and used for each potential variation of an object (e.g., possible shirt color classifications of the machine learning model to be refined).

At S740, a distribution is determined for the population based on the distribution data returned by the generative machine learning model. The distribution may include, for example but not limited to, a percent value for each classification used by the machine learning model representing a respective proportion of that classification as represented in the population data set. As a non-limiting example for colored shirts where classifications of shirt color used by the machine learning model include red, blue, and yellow, the distribution may include a first percentage for red shirts, a second percentage for blue shirts, and a third percentage for yellow shirts.

At S750, one or more thresholds of the machine learning model to be refined are adjusted based on the distribution. In an embodiment, the thresholds are adjusted such that thresholds for classifications which appear more frequently as indicated by the distribution are lower than thresholds for classifications which appear less frequently as indicated by the distribution. In this manner, the thresholds may be adjusted to reflect the actual distribution of the population, thereby mitigating any bias which may be caused by using an artificially inflated number of samples belonging to uncommon classifications (e.g., synthesized samples created for uncommon classifications as discussed herein). This further improves the accuracy of the model in order to ensure accurate performance while using synthesized samples to train the model as described herein.

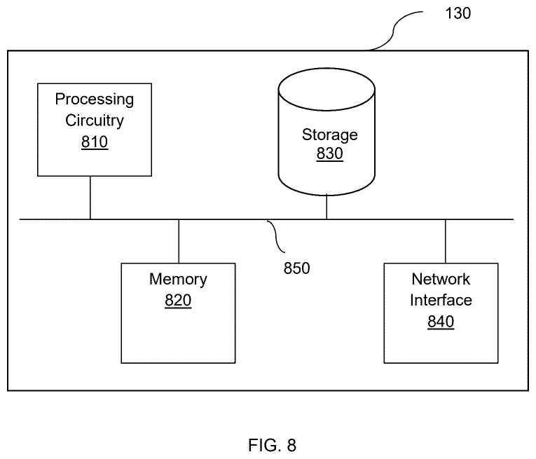

FIG. 8 is a schematic diagram of a machine learning augmenter 130 according to an embodiment. The machine learning augmenter 130 includes a processing circuitry 810 coupled to a memory 820, a storage 830, and a network interface 840. In an embodiment, the components of the machine learning augmenter 130 may be communicatively connected via a bus 850.

The processing circuitry 810 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 820 may be volatile (e.g., random access memory, etc.), non-volatile (e.g., read only memory, flash memory, etc.), or a combination thereof.

In one configuration, software for implementing one or more embodiments disclosed herein may be stored in the storage 830. In another configuration, the memory 820 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 810, cause the processing circuitry 810 to perform the various processes described herein.

The storage 830 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 840 allows the machine learning augmenter 130 to communicate with, for example, the databases 120, the generative model server 140, and the like.

It should be understood that the embodiments described herein are not limited to the specific architecture illustrated in FIG. 8, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2 A; 2 B; 2 C; 3 A; A and B in combination; B and C in combination; A and C in combination; A, B, and C in combination; 2 A and C in combination; A, 3 B, and 2 C in combination; and the like.

What is claimed is:

1. A method for augmented machine learning, comprising:
synthesizing a plurality of second visual content samples, wherein synthesizing the plurality of second visual content samples further comprises removing at least a portion of a plurality of first visual content samples with respect to an object in order to create a plurality of removed portion visual content items and providing the plurality of removed portion visual content items to a generative machine learning model, wherein the generative machine learning model is trained to generate at least a portion of visual content with respect to the plurality of removed portion visual content items;
creating a training set including the synthesized visual content samples; and
training a machine learning model using the training set, wherein the machine learning model is trained to classify visual content with respect to the object.

2. The method of claim 1, wherein removing at least a portion of the plurality of first visual content samples further comprises:
segmenting the plurality of first visual content samples with respect to the object, wherein the at least a portion of the plurality of first visual content samples is removed based on the segmenting of the plurality of first visual content samples with respect to the object.

3. The method of claim 2, wherein segmenting each of the plurality of first visual content samples results in at least one set of pixels corresponding to the object for each first visual content sample, wherein the at least one set of pixels corresponding to the object are removed from at least one of the plurality of first visual content samples.

4. The method of claim 1, further comprising:
querying the generative machine learning model with respect to the plurality of first visual content samples, wherein the query indicates a variation of the object for which the at least a portion of visual content is to be generated by the generative machine learning model.

5. The method of claim 1, wherein the trained machine learning model has a plurality of weights, further comprising:
applying the trained machine learning model to at least one evenly distributed data set in order to produce a set of outputs with respect to the at least one evenly distributed data set, each evenly distributed data set including an evenly distributed set of visual content samples, wherein the trained machine learning model outputs a classification for each visual sample among each evenly distributed data set; and
adjusting at least one weight plurality of weights based on the set of outputs with respect to the at least one evenly distributed data set.

6. The method of claim 1, wherein the generative machine learning model is a first generative machine learning model, wherein the trained machine learning model has a plurality of thresholds, further comprising:
querying a second generative machine learning model for distribution data of a population set; and
adjusting at least one threshold of the plurality of thresholds based on the distribution data of the population set.

7. The method of claim 6, wherein the at least one threshold is adjusted such that the trained machine learning model achieves a predetermined precision rate.

8. The method of claim 6, wherein the second generative machine learning model is a large language model.

9. The method of claim 1, wherein the generative machine learning model is a diffusion model.

10. The method of claim 1, further comprising:
applying the trained machine learning model to a plurality of third visual content samples.

11. A non-transitory computer readable medium having stored thereon instructions for causing a processing circuitry to execute a process, the process comprising:
synthesizing a plurality of second visual content samples, wherein synthesizing the plurality of second visual content samples further comprises removing at least a portion of a plurality of first visual content samples with respect to an object in order to create a plurality of removed portion visual content items and providing the plurality of removed portion visual content items to a generative machine learning model, wherein the generative machine learning model is trained to generate at least a portion of visual content with respect to the plurality of removed portion visual content items;
creating a training set including the synthesized visual content samples; and
training a machine learning model using the training set, wherein the machine learning model is trained to classify visual content with respect to the object.

12. A system for augmented machine learning, comprising:
a processing circuitry; and
a memory, the memory containing instructions that, when executed by the processing circuitry, configure the system to:
synthesize a plurality of second visual content samples, wherein synthesizing the plurality of second visual content samples further comprises removing at least a portion of a plurality of first visual content samples with respect to an object in order to create a plurality of removed portion visual content items and providing the plurality of removed portion visual content items to a generative machine learning model, wherein the generative machine learning model is trained to generate at least a portion of visual content with respect to the plurality of removed portion visual content items;
create a training set including the synthesized visual content samples; and
train a machine learning model using the training set, wherein the machine learning model is trained to classify visual content with respect to the object.

13. The system of claim 12, wherein the system is further configured to:
segment the plurality of first visual content samples with respect to the object, wherein the at least a portion of the plurality of first visual content samples is removed based on the segmenting of the plurality of first visual content samples with respect to the object.

14. The system of claim 13, wherein segmenting each of the plurality of first visual content samples results in at least one set of pixels corresponding to the object for each first visual content sample, wherein the at least one set of pixels corresponding to the object are removed from at least one of the plurality of first visual content samples.

15. The system of claim 12, wherein the system is further configured to:
query the generative machine learning model with respect to the plurality of first visual content samples, wherein the query indicates a variation of the object for which the at least a portion of visual content is to be generated by the generative machine learning model.

16. The system of claim 12, wherein the trained machine learning model has a plurality of weights, wherein the system is further configured to:
apply the trained machine learning model to at least one evenly distributed data set in order to produce a set of outputs with respect to the at least one evenly distributed data set, each evenly distributed data set including an evenly distributed set of visual content samples, wherein the trained machine learning model outputs a classification for each visual sample among each evenly distributed data set; and
adjust at least one weight plurality of weights based on the set of outputs with respect to the at least one evenly distributed data set.

17. The system of claim 12, wherein the generative machine learning model is a first generative machine learning model, wherein the trained machine learning model has a plurality of thresholds, wherein the system is further configured to:
query a second generative machine learning model for distribution data of a population set; and
adjust at least one threshold of the plurality of thresholds based on the distribution data of the population set.

18. The system of claim 17, wherein the at least one threshold is adjusted such that the trained machine learning model achieves a predetermined precision rate.

19. The system of claim 17, wherein the second generative machine learning model is a large language model.

20. The system of claim 12, wherein the generative machine learning model is a diffusion model.

21. The system of claim 12, wherein the system is further configured to:
apply the trained machine learning model to a plurality of third visual content samples.
